(19) United States
(12) Patent Application Publication
(10) Pub. No.: US 2006/0250539 A1
(43) Pub. Date: Nov. 9, 2006

(54) Display

(76) Inventors: Chuan-Pei Yu, I-Lan Hsien (TW); Yi-Chi Luo, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/163,135

(22) Filed: Oct. 6, 2005

(30) Foreign Application Priority Data
May 9, 2005 (TW) 094114903

(51) Int. Cl. G02F 1/1333; G02F 1/1335

(52) U.S. Cl. 349/58; 349/113

(57) ABSTRACT

A display includes a flat display panel, a housing for securing the flat display panel, and a reflecting film secured in the housing and positioned on the display side of the flat display panel.

### BACKGROUND OF THE INVENTION

1. Field of the Invention

The present invention relates to a flat display, and more particularly, to a flat display which has mirror effects.

2. Description of the Prior Art

Due to the fast developments of electronics, the requirements of displays used as interfaces between machines and human are more and more strict. Because liquid crystal displays (LCD) have light weight, thinness, low energy requirements, no radiation, and other good qualities, they have become the main stream in the market and are widely used in notebooks, personal digital assistants (PDA), digital cameras, cellular phones, and other communication and information equipments. On the other hand, organic-light-emitting-diode (OLED) displays have also attention due to the research of organic materials and their advantages of being self-light-emitting, having a high resolution, and having wide view angles. As a result, LCD displays, OLED displays and other flat-panel displays have become indispensable for mobile information electronics.

To satisfy customers, more and more designs of mobile information electronics meet the requirements to provide multi-functions, conveniences, and also fascinating appearances. Manufacturers continuously offer new products. For example, the cellular phone industry has provided phones with dual display structures or with cameras. However, the industry is still continuing to develop more displays and information devices with different functions and exterior designs to meet market demands.

### SUMMARY OF THE INVENTION

It is therefore a primary objective of the claimed invention to provide a display which is equipped with a reflecting film to create mirror effects. Those effects will allow the display to have additional functions and different exteriors to meet market demands.

According to the claimed invention, the display having mirror effects comprises a flat display panel, and a housing to contain and secure the flat display panel, wherein one side of the flat display panel is a display side. The display also has a reflecting film positioned secured in the housing and positioned on top of the display side of the flat display panel.

It is an advantage of the claimed invention that the additional reflecting film in the housing will reflect the lights in the environment and provide mirror effects on the display side of the display so that the display will have various functions and exteriors.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the exterior of a display according to a first embodiment of the present invention.

FIG. 2 is a magnification diagram of the cross-section view along line 2-2 of the display shown in FIG. 1.

FIG. 3 is a schematic diagram of the exterior of a display according to a second embodiment of the present invention.

FIG. 4 is a magnification diagram of the cross-section view along line 4-4 of the display shown in FIG. 3.

FIG. 5 is a schematic diagram of the exterior of a display according to a third embodiment of the present invention.

FIG. 6 is a schematic diagram of the exterior of a display according to a fourth embodiment of the present invention.

### DETAILED DESCRIPTION

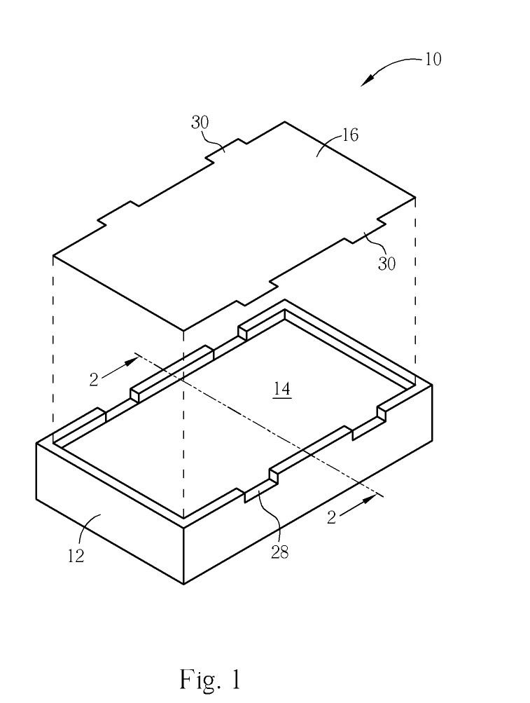

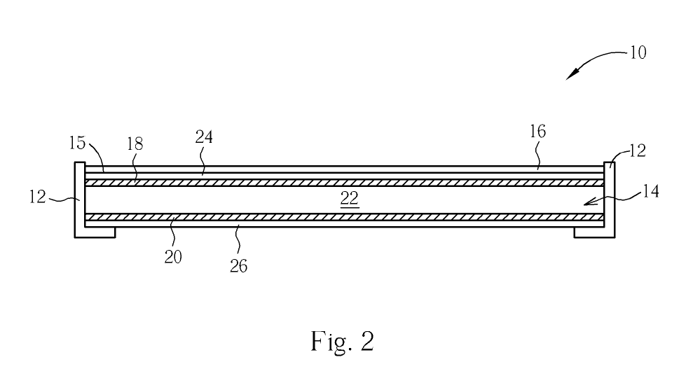

Please refer to FIG. 1 and 2. FIG. 1 shows the exterior of a display 10, the first embodiment of the present invention. FIG. 2 shows the magnification of the cross-section view along line 2-2 of the display 10 shown in FIG. 1. However, FIG. 1 shows the display 10 before it is equipped with the reflecting films 16. The display 10 comprises a housing 12 and a flat display panel 14. The housing 12 contains and secures the flat display panel 14, and is preferably a plastic housing. In this embodiment, the flat display panel 14 is a LCD panel. However, the flat display panel 14 is not limited to being a LCD panel. Other flat display panels, such as OLED, will also work in the display 10 in the present invention. As shown in FIG. 2, the flat display panel 14 has a display side 15 on its top, and comprises a first transparent substrate 18, a second transparent substrate 20 under the first transparent substrate 18, and a liquid crystal layer 22 positioned between the two first and second transparent substrates 18, 20. The first and second transparent substrates 18, 20 are made of glass, quartz, and other non-conductive transparent materials. The flat display panel 14 further comprises a first polarizer 24 and a second polarizer 26 positioned on the upper surface of the first transparent substrate 18 and on the lower surface of the second transparent substrate 20 respectively. In addition, because a LCD usually needs a backlight, the present invention display 10 selectively comprises an edge-type or a direct-type backlight (not shown) so as to provide the light source for the flat display panel 14 to display images. The backlight and the housing 12 can be made as a backlight module. That means the housing 12 is an essential part of the backlight module. However, if the flat display panel 14 is an OLED panel, the backlight is not needed.

The display 10 further comprises a reflecting film 16 secured on the housing 12 and on top of the flat display panel 14. To effectively secure the reflecting film 16 on the housing 12, the housing 12 may have positioning troughs 28 on the top of the housing 12. The reflecting film 16 may also have corresponding positioning raised faces 30 to the troughs 28. In this embodiment, there are four positioning troughs 28 in the housing 12 to secure the reflecting film 16. Therefore, while the reflecting film 16 is set up on the display 10 (as in FIG. 2), the positioning raised faces 30 will be stuck in the troughs 28 to stabilize the reflecting film 16 on the display panel 14.

It should be noted that the reflecting film 16 can be any kind of transparent or semi-transparent films with reflecting qualities, such as transflective films. The reflecting film 16 is capable of fully or partially reflecting the environmental lights of the display 10 and also allows the light of the display side 15 to pass through. As a result, when the display 10 is turned on, the user will see both the light from the flat display panel 14 and the reflected environmental lights. When the display 10 is off, only the environmental lights will be reflected and seen, which creates the mirror effects of the display 10.

In addition, a dual brightness enhancement film (DBEF) by 3M, a polarization conversion film (PCF) by Nitto, or other polarization conversion thin films can also be used as the reflecting film 16. These films allow lights polarizing in a particular direction to penetrate, and reflect the lights polarizing perpendicularly towards the particular direction. In order not to affect the brightness of the flat display panel 14, the transmission axis of the polarization conversion thin film should be parallel to that of the first polarizer 24 if the flat display panel 14 is a LCD panel. This will allow the lights from the display side 15 to penetrate, and will reflect the environmental lights which are polarized perpendicularly to the transmission axis of the first polarizer 24. As a result, the lights from the first polarizer 24 will penetrate the reflecting film 16 made of a polarization conversion thin film and form images in the user's eyes. On the other hand, certain environmental lights which are polarized perpendicularly to the transmission axis of the first polarizer 24 will be reflected by the reflecting film 16 and create mirror effects. In another embodiment of the present invention, the first polarizer 24 may be omitted on the flat display panel 14 if the reflecting film 16 is a polarization conversion thin film, which will reduce the manufacturing cost and the thickness of the products.

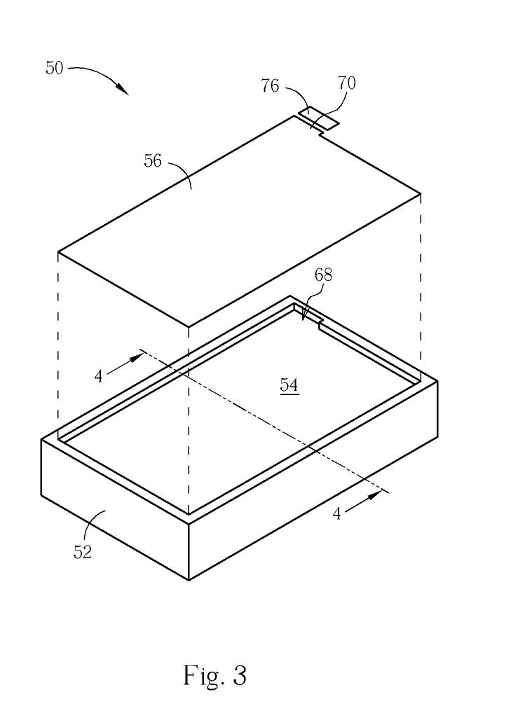

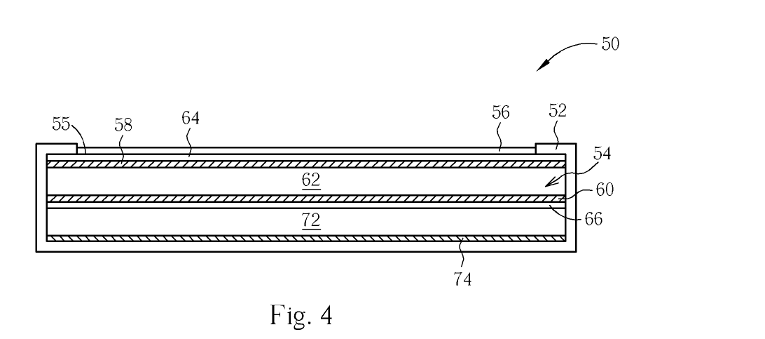

Please refer to FIG. 3 and FIG. 4. FIG. 3 is the schematic diagram of the exterior of a display 50 according to the second embodiment of the present invention, and FIG. 4 is the magnification diagram of the cross-section view along line 4-4 of the display 50 shown in FIG. 3, wherein FIG. 3 shows the display 50 before equipping with the reflecting film 56. The display 50 comprises a housing 52, a LCD panel 54 in the housing 52, a reflecting film 56 on the display side 55 of the LCD panel 54, and a backlight module positioned under the LCD panel 54 and in the housing 52 to provide the light source that the LCD panel 54 needs.

As shown in FIG. 4, the LCD panel 54 contains a first transparent substrate 58, a second transparent substrate 60, and a liquid crystal layer 62. And a first polarizer 64 and a second polarizer 66 are positioned on the outer surface of first and second transparent substrate 58, 60 respectively. The backlight module includes a light source (not shown), a light guide plate 72, a reflecting layer 74 positioned on the lower surface of the light guide plate 72, and a plurality of layers of optical thin films (not shown) on the light guide plate 72 to increase the brilliance of lights. In this embodiment, the housing 52 has a liquid crystal input trough 68 to allow the liquid crystal molecules of the liquid crystal layer 62 be poured into the space between the first and second transparent substrates 58, 60. Therefore, the reflecting film 56 may be designed to have a corresponding raised face 70 to the liquid crystal input trough 68, so that the reflecting film 56 will be effectively secured on the housing 52. In addition, to increase the security of the reflecting film 56, some positioning glue 76, such as thin single sided tapes, double sided tapes, and UV adhesives, may be used while the reflecting film 56 is set up.

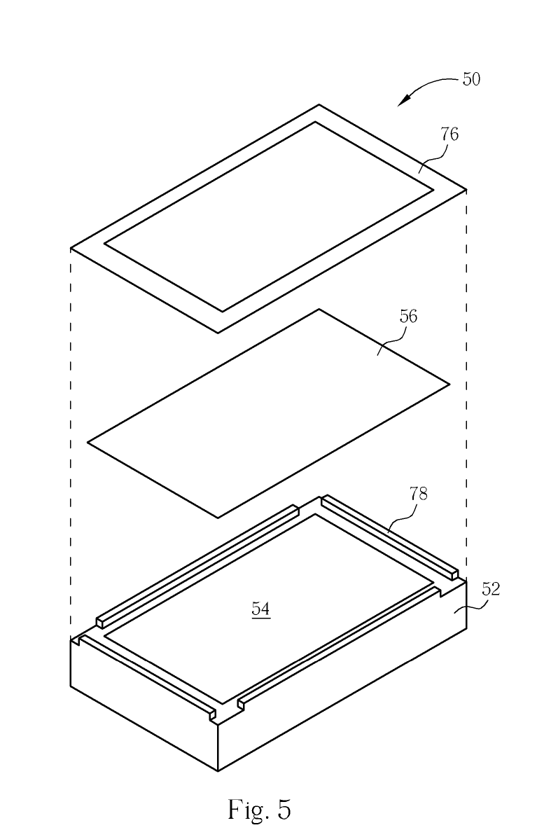

Please refer to FIG. 5. FIG. 5 shows a display 50 according to a third embodiment of the present invention, wherein component numerals used in FIG. 5 will be the same as in FIG. 3 for illustration. The display 50 contains a backlight module 52, which includes a housing (as the backlight module portion drawn in this figure), a light source in the housing, a light guide plate, and a plurality of optical thin films (not shown). The display 50 further comprises a flat display panel 54 on the backlight module 52, and a reflecting film 56 on the flat display panel 54. In addition, at least one positioning hook 78 is disposed on the edges of the housing of the backlight module 52 for securing the reflecting film 56 on the flat display panel 54. In this embodiment, there is one positioning hook 78 on each side of the surface of the housing of the backlight module 52 to secure the sides of the reflecting film 56. However, the positioning hooks 78 may also be selectively designed to be combined in pairs and form a rectangular frame on the backlight module 52. In a preferable embodiment, the positioning hooks 78 and the housing of the backlight module 58 are a monolithic structure. In addition, glue may be used to effectively secure the reflecting film 56. In FIG. 5, a single sided tape 76 shaped as a rectangular frame is used to put on top of the reflecting film 56 and the housing of the backlight module 52 to attach the reflecting film 56 to the top of the backlight module 52. Double sided tapes and other tapes may also be used between the reflecting film 56 and the housing of the backlight module 52 to secure the reflecting film 56. Other tools with glue or positioning functions may also be used in the present invention.

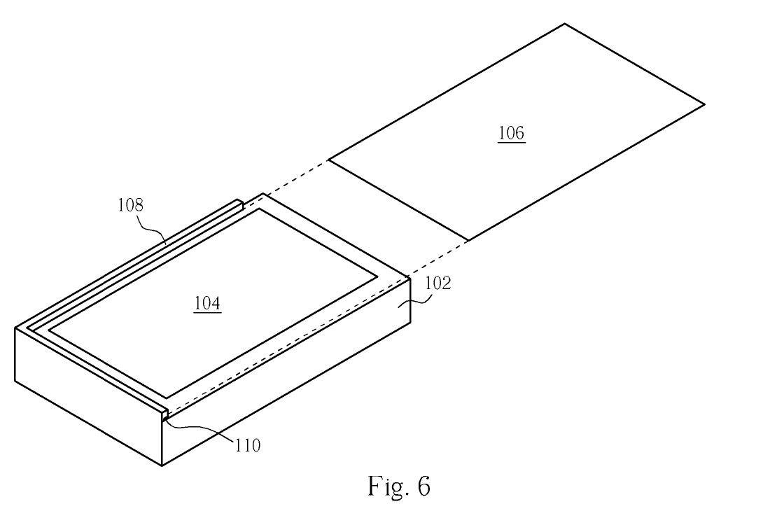

Please refer to FIG. 6. FIG. 6 shows the exterior of a display 100 according to the fourth embodiment of the present invention. The display 100 comprises a backlight module housing 102, a plurality of elements of the backlight module (not shown), a flat display panel 104 secured in the backlight module housing 102, and a reflecting optical film 106. One thing to notice is that a positioning die mould is set on the backlight module housing 102 to secure the optical film 106 on the flat display panel 104. In FIG. 6, the positioning die mould 108 is an L-shaped elastic structure. A narrow opening 110 is between the L-shaped structure and the backlight module housing 102. The narrow opening 110 and the L-shaped structure help to place and fix the optical film 106 onto the surface of the flat display panel 104. The design of the positioning die mould 108 does not have to be the same as what is shown in FIG. 6. Any positioning die moulds using mechanical methods, pressures, or other methods to secure the reflecting film 106 may also work in the present invention.

One thing to notice is that the third and fourth embodiments do not need positioning raised faces for the reflecting films 56 and 106 since there are positioning hooks 78 and positioning die moulds 108 on the backlight module 52 and the backlight module housing 102. Therefore, regular reflecting films, which are rectangular or fit the size of the flat display panel, may be used in the present invention.

In contrast to the prior art, the present invention comprises an extra reflecting transparent or semi-transparent film on the housing of a display to cover the display side of the display panel. Therefore, the user may see the images created by the display panel and also simultaneously sees the light reflected by the reflecting film. While the display is not displaying images, only the reflected environmental lights will be seen, which creates the mirror effects. These effects increase the functions and practicability of the display.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display with mirror effects, the display comprising:
a flat display panel having a display side;
a housing for containing and fixing the flat display panel; and
a reflecting film fixed in the housing and on top of the flat display panel.

2. The display of claim 1, wherein the housing comprises at least one positioning trough or at least one positioning die mould for fixing the reflecting film.

3. The display of claim 2, wherein the reflecting film comprises at least one positioning raised face corresponding to the positioning trough, which is placed into the positioning trough to secure the reflecting film on the housing while the reflecting film is set up.

4. The display of claim 3, wherein the housing comprises a plurality of the positioning troughs positioned on opposite sides of the housing from each other and the reflecting film comprises a plurality of the positioning raised faces, each of the positioning troughs having a corresponding positioning raised face.

5. The display of claim 2, wherein the positioning trough is a liquid crystal input trough.

6. The display of claim 1, wherein the display further comprises at least one positioning glue for securing the reflecting film in the housing, the glue being a single sided tape, a double sided tape, or an UV adhesive.

7. The display of claim 1, wherein the reflecting film is a film with a reflecting functionality, and is a transflective film or a polarization converter thin film.

8. The display of claim 7, wherein the transflective film reflects environmental lights while allowing lights produced by the display to penetrate.

9. The display of claim 1, wherein the flat display panel is a liquid crystal display (LCD) panel or an organic-light-emitting-diode (OLED) display panel.

10. The display of claim 9, wherein the LCD panel comprises:
a first transparent substrate;
a second transparent substrate correspondingly under the first transparent substrate; and
a liquid crystal layer between the first and the second transparent substrate.

11. The display of claim 10, wherein the flat display panel further comprises:
a first polarizer on an upper surface of the first transparent substrate; and
a second polarizer on an lower surface of the second transparent base panel.

12. The display of claim 11, wherein the reflecting film allows lights from the display side to penetrate while reflecting lights are polarized perpendicularly to the transmission axis of the first polarizer.

13. The display of claim 9, wherein the display further comprises a backlight module to provide light source for the flat display panel.

14. The display of claim 1 wherein the housing is a plastic housing or an element of a backlight module.

15. A display with mirror effects, the display comprising:
a flat display panel having a display side; and
a reflecting film positioned on top of the display side.

16. The display of claim 15, wherein the reflecting film is a polarization reflecting thin film or a transflective film.

17. The display of claim 16, wherein the transflective film allows lights from the display side to penetrate while reflecting environmental lights.

18. The display of claim 15, wherein the flat display panel is a LCD panel or an OLED display panel.

19. The display of claim 18, wherein the LCD panel further comprises:
a first transparent substrate;
a second transparent substrate correspondingly under the first transparent substrate;
a liquid crystal layer between the first and the second transparent substrates;
a first polarizer on an upper surface of the first transparent substrate; and
a second polarizer on an lower surface of the second transparent substrate.

20. The display of claim 19, wherein the reflecting film allows lights from the display side to penetrate while reflecting lights polarized perpendicularly to the transmission axis of the first polarizer.

21. The display of claim 15, wherein the display further comprises a backlight module to provide a light source for the flat display panel.
